(19) United States
(12) Patent Application Publication
(10) Pub. No.: US 2016/0180813 A1
(43) Pub. Date: Jun. 23, 2016

(54) METHOD AND DEVICE FOR DISPLAYING OBJECTS

(71) Applicants: Wei ZHOU, Beijing (CN); Lin DU, Beijing (CN); Yan XU, Beijing (CN); THOMSON LICENSING, Issy les Moulineaux (FR)

(72) Inventors: Wel ZHOU, Beijing (CN); Lin DU, Beijing (CN); Yan XU, Beijing (CN)

(21) Appl. No.: 14/907,552

(22) PCT Filed: Jul. 25, 2013
(86) PCT No.: PCT/CN2013/080099

§ 371 Date: Jan. 25, 2016

(51) Int. Cl. G09G 5/12; G06F 3/0482; G06F 3/0484; H04W 4/02; G09G 5/14

(52) U.S. Cl. CPC G09G 5/12; H04W 4/023; G09G 5/14; G06F 3/04842; G06F 3/0482; G09G 2300/026

(57) ABSTRACT

It is provided a method for displaying objects. The method comprises, at the side of a first device, steps of detecting distance between the first device and a second device, wherein the second device displays one or more objects; if the distance becomes less than a threshold value, displaying at least one object among the one or more objects on the first device.

### TECHNICAL FIELD

The present invention relates to user interaction, and more particularly relates to a method and a device for displaying objects.

### BACKGROUND

Multi-screen interactivity (e.g. second screen, triple play, and etc.) is a human computer interaction technology involving multiple displays and input devices, such as TV, personal computer, mobile and tablet, which gives users another way of issuing commands and consuming media content. Nowadays, users are no longer fixed to high computing desktops; they are surrounded by digital ecosystems and information networks. A challenge in the multi-device system is how to incorporate interaction techniques that are not only intuitive, but also allow users to easily and quickly interact with the many functions and features.

### SUMMARY

According to an aspect of the present invention, it is provided a method for displaying objects. The method comprises, at the side of a first device, steps of detecting distance between the first device and a second device, wherein the second device displays one or more objects; if the distance becomes less than a threshold value, displaying at least one object among the one or more objects on the first device.

The method further comprises steps of detecting a contact on the first device when the distance is less than the threshold value; displaying the one or more objects on the first device; detecting a release of the contact; detecting the distance between the first device and the second device; and if the distance is less than the threshold value, deleting the one or more objects except the at least one object from the first device.

The method further comprises a step of If the distance is not less than the threshold value, keeping the one or more objects on the first device.

According to another aspect of the present invention, it is provided a method for displaying objects. The method comprises, at the side of a second device, steps of detecting distance between a first device and the second device, wherein the second device displays one or more objects; if the distance becomes less than a threshold value, moving at least one object among the one or more objects from the second device to the first device.

The method further comprises a step of determining the at least one object that have closest distance to the first device.

The method further comprises a step of determining the at least one object based on user's selection on the at least one object.

Further, all objects displayed on the second device are associated with sequence number, and the method further comprises a step of determining the at least one object with the largest sequence number or the smallest sequence number.

According to another aspect of the present invention, it is provided a device for displaying objects, comprising an inputting module for detecting distance between the device and a second device; a displaying module for displaying objects; and a processing module for determining whether or not the distance becomes less than a threshold value; and for, if determining the distance becomes less than the threshold value, instruct the displaying module to display at least one object among the one or more objects that are previously displayed on the second device.

Further, the inputting module is further used for detecting contact and release of contact on the device; and the processing module is further used for, if detecting a contact while the distance is less than the threshold value, instructing the displaying module to display the one or more objects, and for, if detecting a release of the contact when he distance is less than the threshold value, instructing the displaying module to delete the one or more objects except the at least one object.

Further, the processing module is further used for determining the at least one object based on one of following methods including a) the at least one object has closest distance to the device; b) the at least one object is selected by a user; and c) all objects are associated with sequence number, and the at least one object corresponds to the largest sequence number or the smallest sequence number.

It is to be understood that more aspects and advantages of the invention will be found in the following detailed description of the present invention.

### BRIEF DESCRIPTION OF THE DRAWINGS

The accompanying drawings, which are included to provide a further understanding of the invention and are incorporated in and constitute a part of this application, will be used to illustrate an embodiment of the invention, as explained by the description. The invention is not limited to the embodiment.

In the drawings:

FIG. 1 is a block diagram showing a system for shifting displayed content between two devices according to an embodiment of present invention;

FIGS. 2A to 2E are diagrams showing an example about shift of objects between the two tablets according to the embodiment of present invention; and

FIG. 3 is a flow chart showing a method for moving objects between the two tablets according to the embodiment of the present invention.

### DETAILED DESCRIPTION

The embodiment of the present invention will now be described in detail in conjunction with the drawings. In the following description, some detailed descriptions of known functions and configurations may be omitted for clarity and conciseness.

The present invention provides a method, a device and system for a multi-screen interaction so as to give users natural interaction experience. One or more displayed objects on the two screens are shifted between them when the two screens are moved close to each other, or far away from each other.

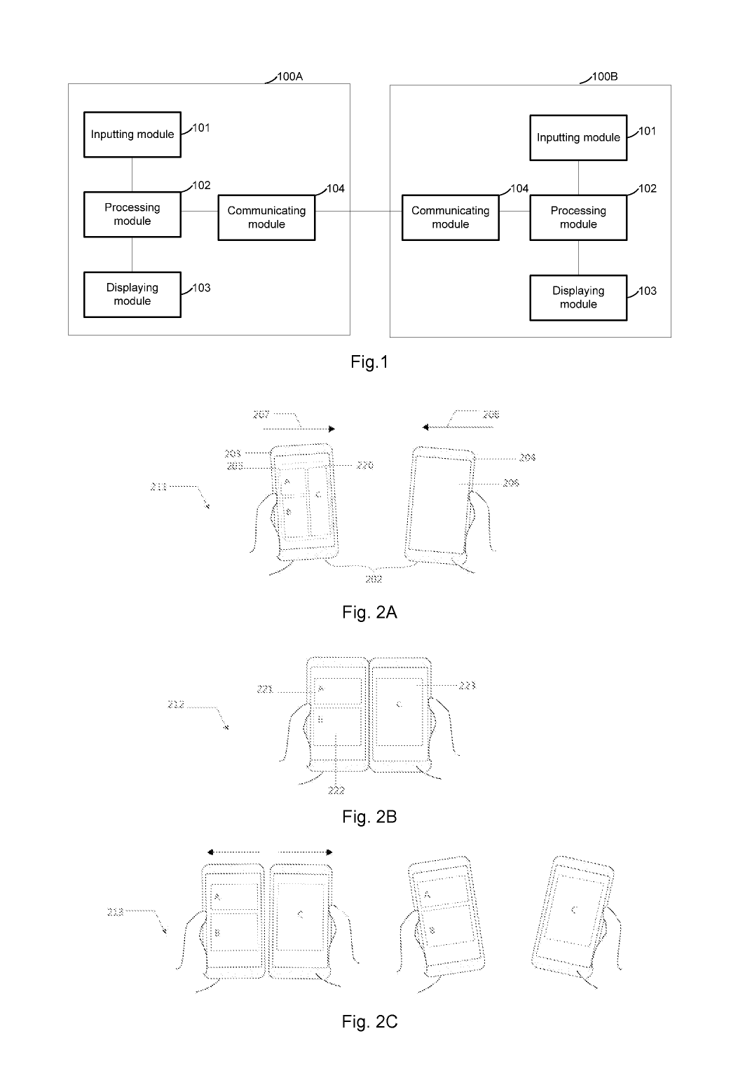

FIG. 1 is a block diagram showing a system for shifting displayed content between two devices according to an embodiment of present invention. In the embodiment, the system comprises two identical devices 100A and 100B. Each device has an inputting module 101, a processing module 102, a displaying module 103, a communicating module 104 and a storage (not shown) for storing data. Their functions and hardware implementations are described as followed.

The inputting module 101 is used to receive user inputs, which include not only the single touch, multi-touch on the touch screen and button press, but also the motion inputs on the device. For example, the motion inputs include translation movement of one device towards or far away from the other device and rotatory movement of the device. Accordingly, hardware corresponding to the inputting module 101 includes touch screen, a physical button and one or more sensors (e.g. gyro sensor, G sensor, magnetic field sensor, acceleration sensor, distance sensor, proximity sensor etc.). In the example shown below, one sensor is used, i.e. a magnetic field sensor to detect the distance and movement direction between the two devices because magnetic field sensor is capable of providing a measure of magnetic field strength along x, y and z directions. However, it shall note that other sensors are also possible to use for detecting distance and movement direction.

The processing module 102 is used to process data according to algorithms and provide data to the displaying module 103 for display and to the communicating module 104 for transmission to the other device. The details will be described below in connection with the method. Hardware corresponding to the processing module 102 includes central processing unit (CPU), and in some cases, it may include graphic processing unit (GPU) for processing image data for display.

The displaying module 103 is used to display contents. Hardware corresponding to the displaying module 103 includes a touch screen. In one embodiment, the contents are computer objects including window, box, image, document, icon etc.

The communicating module 104 is used to transmit and receive data. Hardware corresponding to the communicating module 104 includes network interface or network adapter. It can be wired network adapter, e.g. cable or wireless network adapter, e.g. Bluetooth, ZigBee, WiFi or WiMAX.

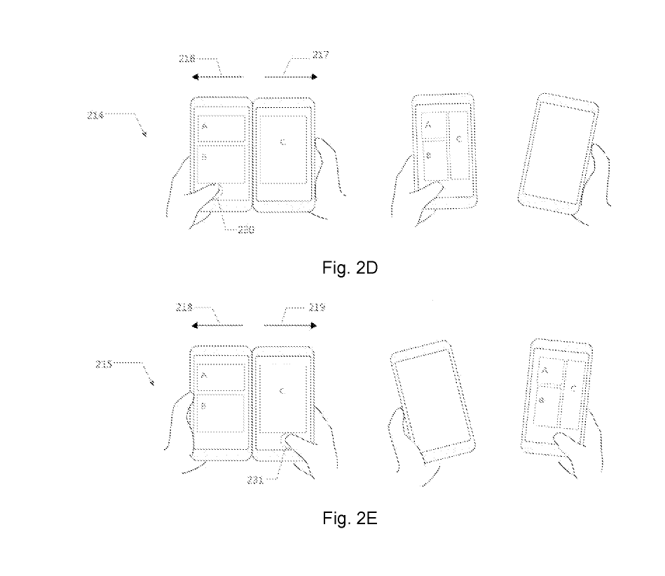

FIGS. 2A to 2E show an example about shift of objects between the two tablets 203 and 204. In the example, there are 3 objects, i.e. object A, object B and object C. In this example, the objects A, B and C are images. It shall note that types of objects A, B and C can be different, e.g. object A is an image, object B is a window or box holding a text comment about the image and object C is an icon linking to an external document. Specifically, FIGS. 2A to 2C show move of the object C from a first device 203 to a second device 204; FIG. 2D shows move of the object C from the second device 204 to the first device 203 with contact between finger and the first device maintained; and FIG. 2E shows move of the objects A and B from the first device 203 to the second device 204 with contact between finger and the second device maintained.

In the view 211 of FIG. 2A, all contents (objects A, B and C) of a detachable user interface 220 are displayed on the first screen 203, and nothing of the detachable user interface 220 is displayed on the second screen 204. And the first device and second device are moved close to each other. Reference numerals 207 and 208 show direction of translation movement. Herein, “detachable” means that any one of detachable objects shown in the user interface is able to be moved to another device and be separated from other objects.

In the view 212 of FIG. 2B, when the two devices are moved to contact each other or the distance between them is below a predefined threshold value, the object C 223 of the UI 220 is moved to the screen of the second device. The objects A and B 221 222 remain on the screen of the first device and the width of the objects is scaled to width of the screen so as to eliminate the blank area caused by the move of the object C.

In the view 213 of the FIG. 2C, the two devices are moved away from each other, and the objects A and B 221,222 remain on the first device, and the object C 223 remain on the second device. So the contents of the user interface 220 are separated from one screen to two screens.

In the view 214 of the FIG. 2D, the two devices are moved away from each other with a touch on the screen of the first device maintained, and the object C is moved to the first device, and the width of all objects are scaled based on the screen width, i.e. the width of an area including all objects equals to the screen width of the first device.

In the view 215 of the FIG. 2E, the two devices are moved away from each other with a touch on the screen of the second device maintained, and the objects A and B are moved to the second device, and the width of all objects are scaled based on the screen width, i.e. the width of an area including all objects equals to the screen width of the second device.

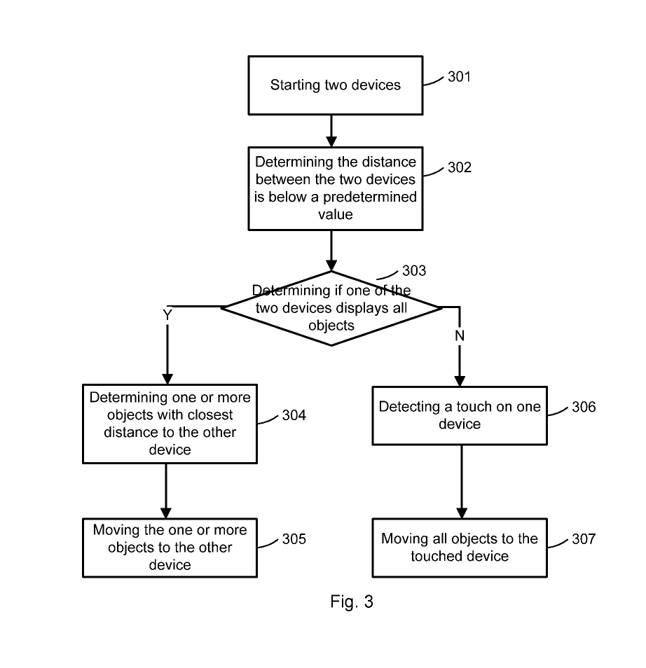

FIG. 3 is a flow chart showing a method for moving objects between the two tablets according to the embodiment of the present invention.

In the step 301, the two devices are started. After the starting up, the two devices are automatically connected to each other via their communicating modules.

In the step 302, because both devices have magnetic field sensors, each of them can be aware of the change in distance between them. If it is determined (the two devices both can make the determination, or only one device makes the determination and uses messages to inform the determination result to the other device) the distance is below a predetermined threshold value, then it goes to the step 303. Actually, because this example uses the magnetic field sensor, the determination step can be simplified to a determination on whether or not the magnetic field strength outputted by the magnetic field sensor is above a predefined magnetic field strength value.

In the step 303, it is determined if one of the two devices displays all objects, which means one device displays one or more objects and the other device displays no object. The determination can be implemented in two ways: a) the two devices send the information about their displayed objects to each other, and make a determination themselves based on the information about their displayed objects and received information about displayed objects on the other device; and b) one device is marked as host device and the other device is marked as client device, the client device sends information about its displayed objects to the host device, the host device makes a determination based on information about the displayed objects on the host device and received information about the displayed objects on the client device. If yes, it goes to the step 304; or otherwise, it goes to the step 306.

In the step 304, one or more objects with closest distance to the device that displays no object are determined. The determination step is implemented by a) determining which side (upside, down side, left side and right side) of the device displaying all objects is closest side to the other device by using the magnetic field strength, b) obtaining position information of the displayed objects on the device that displays all objects and c) determining the one or more objects based on the magnetic field strength and the position information of the displayed objects. In an example as illustrated in FIG. 2A, a) when the second device 204 is contacted or moved closer to the upside of the first device 203, the objects A and C are determined as they have the closest distance to the second device 204, b) when the second device 204 is contacted or moved closer to the down side of the first device 203, the objects B and C are determined as they have the closest distance to the second device 204, c) when the second device 204 is contacted or moved closer to the left side of the first device 203, the object A and B are determined as they have the closest distance to the second device 204 and d) when the second device 204 is contacted or moved closer to the right side of the first device 203, the object C is determined as it has the closest distance to the second device 204.

In the step 305, the determined one or more objects are moved to the device that displays no object, and sizes of the one or more objects are scaled to screen size of the device that displays no object. After the move out of the one or more objects, sizes of remaining objects are scaled to screen size of the device previously displaying all objects. The one or more objects will remain on the device that previously displays no object when the two devices are moved away from each other.

In the step 306, one of two devices detects a touch on it.

In the step 307, the objects on the device that is not touched are moved to the device that is touched, and consequently, all objects are displayed on the device that is touched, and size of an area holding all objects is scaled to the screen size. Herein, there are many methods for arranging all objects in the area. A first method is that absolute positions or relative positions of all objects are predefined in a database. A second method is that the objects from the untouched device are moved and placed in blank area or unused area in the screen of the touched device. A third method is that the touched device firstly combine area holding objects in the touched device and area holding objects in the untouched device to form a new area and then scale down the size of the new area to the screen size. In order to make all objects remain on the touched device after releasing touch (or called contact between user finger or other touching object and the screen), the touch shall not be released until the distance between the two devices become larger than the predetermined threshold value by moving the two devices away from each other with contact maintained.

Herein, if the touch on the device is released when the distance between the two devices is still below the predetermined threshold value, there are two methods to handle it. A first method is that it goes to the step 304 (now shown in the FIG. 3). It means one or more objects among all objects displayed in the touched device will be moved to the untouched device. A second method is that objects previously displayed on the untouched device are moved back to the untouched device. In order to enable the second method, each device has a database storing information about which objects are displayed on the device before it is touched in the step 306.

According to a variant of the present embodiment, the device further has an acceleration sensor for detecting if a device is moved; therefore, the magnetic field sensor is only enabled when the acceleration sensor detects a move.

In the present embodiment, one or more objects are determined based on distance from objects displayed in one device to the other device. In a variant of the present embodiment, the user can select one or more objects to move to the other device after the step 302.

In the present embodiment, the two devices are both tablets and have same hardware components. According to another variant of the embodiment, the two devices don't have same hardware components. For example, one device is a STB with a TV or a display connected and the other device is a tablet. The STB and the tablet are interconnected, the magnetic field sensor is placed on the TV, and the touch can only be applied on the tablet. When the distance between the tablet and the TV becomes below the predetermined threshold value by moving tablet close to the TV, the steps 303, 304, 305, 306 and 307 would be performed.

According to a variant of the embodiment, a copy of the one or more objects is sent from one device to the other device instead of moving them to the other device.

According to a variant of the present embodiment, all objects displayed on one device have a sequence number and are moved to the other device in an ordinal and one-by-one manner, which means the steps 303, 304, 305, 306 and 307 are not performed in this variant, and each time the distance between the two device becomes below the predetermined threshold value, one object with largest or smallest sequence number is moved to the other device.

According to a variant of present embodiment, only steps 301, 302, 304 and 305 are used. When the distance between a first device that displaying objects and a second device that may display no objects or some objects becomes below the predetermined threshold value in the step 302, it is determined one or more objects in the first device in the step 304 and move the determined one or more objects to the second device in the step 305. Herein, the determined one or more objects can be added to or replace its currently displayed objects (either no object or some objects).

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application and are within the scope of the invention as defined by the appended claims.

1. A method for displaying objects, wherein comprising, at the side of a first device, steps of
detecting distance between the first device and a second device, wherein the second device displays one or more objects; and
according to the distance between the first device and the second device displaying by the first device at least one object among the one or more objects, wherein the at least one object has closest distance to the first device compared to remaining objects among the one or more objects that were all previously displayed on the second device.

2. The method of the claim 1, further comprising steps of
detecting a contact on the first device when the distance is less than the threshold value;
displaying the one or more objects on the first device;
detecting a release of the contact;
detecting the distance between the first device and the second device; and
if the distance is less than the threshold value, deleting the one or more objects except the at least one object from the first device.

3. The method of the claim 2, further comprising a step of
If the distance is not less than the threshold value, keeping the one or more objects on the first device.

4. A method for displaying objects, wherein comprising, at the side of a second device, steps of
detecting distance between a first device and the second device, wherein the second device displays one or more objects; and
if the distance becomes less than a threshold value, moving at least one object among the one or more objects from the second device to the first device.

5. The method of claim 1 or 4, further comprising a step of determining the at least one object.

6-7. (canceled)

8. A device for displaying objects, comprising
an inputting sensor for detecting distance between the device and a second device;
a displaying screen for displaying objects; and
a processor for determining whether or not the distance becomes less than a threshold value; and for instruct the displaying screen to display at least one object among the one or more objects according to the distance between the first device and the second device, wherein the at least one object has closest distance to the device compared to remaining objects among the one or more objects that were all previously displayed on the second device.

9. The device of the claim 8, wherein,
the inputting sensor is further used for detecting contact and release of contact on the device;
the processor is further used for, if detecting a contact while the distance is less than the threshold value, instructing the displaying screen to display the one or more objects, and for, if detecting a release of the contact when the distance is less than the threshold value, instructing the displaying screen to delete the one or more objects except the at least one object.

10. The device of the claim 9, wherein,
the processor is further used for determining the at least one object based on one of following methods including a) the at least one object has closest distance to the device; b) the at least one object is selected by a user; and c) all objects are associated with sequence number, and the at least one object corresponds to the largest sequence number or the smallest sequence number.
